(19) United States
(12) Patent Application Publication
(10) Pub. No.: US 2010/0152987 A1
(43) Pub. Date: Jun. 17, 2010

(54) TRAVELING VEHICLE

(75) Inventor: Naoki Gorai, Tokyo (JP)

Correspondence Address: BACON & THOMAS, PLLC, 625 SLATERS LANE, FOURTH FLOOR, ALEXANDRIA, VA, 22314-1176, US

(73) Assignee: Kabushikikaisha Equos Research, Tokyo (JP)

(21) Appl. No.: 12/447,493

(22) PCT Filed: Oct. 29, 2007
(86) PCT No.: PCT/JP2007/071011

§ 371 Date: Mar. 2, 2010

(30) Foreign Application Priority Data
Oct. 31, 2006 (JP) 2006-295333

(51) Int. Cl. G06F 19/00

(52) U.S. Cl. 701/70; 701/124

(57) ABSTRACT

A traveling vehicle (1) having a vehicle body (2), vehicle wheels (12) that are supported rotatably by the vehicle body (2) and provided coaxially, and a vehicle body right-left tilting device (53) that tilts the vehicle body (2) to the right and left relative to the vehicle wheels (12) includes: slope inclination measuring means (101) for measuring an inclination of a slope; vehicle body inclination measuring means (102) for measuring an inclination of the vehicle body relative to a vertical of the slope; and a calculation processing device (111) for controlling the vehicle body right-left tilting device (53) from measurement values of the slope inclination measuring means (101) and the vehicle body inclination measuring means (102).

### TECHNICAL FIELD

The present invention relates to a vehicle including a vehicle body, vehicle wheels provided in parallel, and a mechanism for controlling a posture of the vehicle body relative to the vehicle wheels, and more particularly to a traveling vehicle capable of securing passenger comfort by controlling the posture of the vehicle body on an inclined plane.

### BACKGROUND ART

In a conventional wheelchair, driving means are driven on the basis of current camber angles of caster wheels and an inclination of a vehicle body, and advancement stability is improved by adjusting the camber angles of the caster wheels such that the angle of the caster wheels relative to a vertical plane is identical to the angle of the caster wheels during travel on a horizontal plane (see Patent Document 1).

In another wheelchair, the advancement performance is improved by controlling the torque distribution of right and left wheels (see Non-Patent Document 1).

Patent Document 1: Japanese Patent Application Publication No. JP-A-2001-104394

Non-Patent Document 1: Lateral Disturbance Rejection and One Hand Propulsion Control of a Power Assisting Wheelchair, Sehoon Oh and Yoichi Hori, IECON 2005, 2005/11/6-10, Raleigh, N.C.

### DISCLOSURE OF THE INVENTION

However, in the inventions described in Patent Document 1 and Non-Patent Document 1, tilting of the vehicle body itself cannot be controlled even though the tread is narrow and the center of gravity is high. Therefore, when traveling across an inclined plane, the vehicle body tilts, causing a seat surface to tilt such that passenger comfort decreases, and the center of gravity shifts toward a valley side, causing instability. Hence, the vehicle body may topple over due to a passenger operation or an external disturbance.

The present invention has been designed to solve this problem, and an object thereof is to provide a traveling vehicle capable of securing passenger comfort and vehicle body stability even on an inclined plane.

For this purpose, the present invention provides a traveling vehicle having a vehicle body, vehicle wheels that are supported rotatably by the vehicle body and provided in parallel, and a vehicle body right-left tilting device that tilts the vehicle body to the right and left relative to the vehicle wheels, including: slope inclination measuring means for measuring an inclination of a slope; vehicle body inclination measuring means for measuring an inclination of the vehicle body relative to a vertical of the slope; and a calculation processing device for controlling the vehicle body right-left tilting device from measurement values of the slope inclination measuring means and the vehicle body inclination measuring means.

Further, the calculation processing device controls the vehicle body to be substantially horizontal.

Further, when an absolute value of a difference between the measurement values of the slope inclination measuring means and the vehicle body inclination measuring means is smaller than a predetermined value, the calculation processing device does not execute control.

The traveling vehicle further includes: turning radius measuring means for measuring a turning radius when the traveling vehicle performs a turn; and vehicle speed detecting means for measuring a vehicle speed of the traveling vehicle, and the calculation processing device controls the vehicle body right-left tilting device to a vehicle body inclination that takes the turn into account from measurement values of the turning radius measuring means and the vehicle speed detecting means.

Further, when an absolute value of a difference between a posture angle that takes the turn into account and the difference between the measurement value of the slope inclination measuring means and the measurement value of the vehicle body inclination measuring means is smaller than a predetermined value, the calculation processing device does not execute control.

Further, when the measurement value of the slope inclination measuring means is equal to or greater than a predetermined value, the calculation processing device executes control to stop the vehicle.

### EFFECTS OF THE INVENTION

The present invention is a traveling vehicle having a vehicle body, vehicle wheels that are supported rotatably by the vehicle body and provided in parallel, and a vehicle body right-left tilting device that tilts the vehicle body to the right and left relative to the vehicle wheels, including: slope inclination measuring means for measuring an inclination of a slope; vehicle body inclination measuring means for measuring an inclination of the vehicle body relative to a vertical of the slope; and a calculation processing device for controlling the vehicle body right-left tilting device from measurement values of the slope inclination measuring means and the vehicle body inclination measuring means, and therefore a posture of the vehicle body can be controlled appropriately in accordance with the inclination of the slope.

Further, the calculation processing device controls the vehicle body to be substantially horizontal, and therefore riding comfort is improved, leading to an improvement in passenger comfort. Moreover, by positioning a center of gravity in the center of a tread, improvements in right-left stability and advancement performance are achieved.

Further, when an absolute value of a difference between the measurement values of the slope inclination measuring means and the vehicle body inclination measuring means is smaller than a predetermined value, the calculation processing device does not execute control, and therefore slight tilting is permitted. Thus, excessive control is suppressed, enabling an improvement in riding comfort and a reduction in the load on an ECU.

The traveling vehicle further includes: turning radius measuring means for measuring a turning radius when the traveling vehicle performs a turn; and vehicle speed detecting means for measuring a vehicle speed of the traveling vehicle, and the calculation processing device controls the vehicle body right-left tilting device to a vehicle body inclination that takes the turn into account from measurement values of the turning radius measuring means and the vehicle speed detecting means. Therefore, finer control can be performed.

Further, when an absolute value of a difference between a posture angle that takes the turn into account and the difference between the measurement value of the slope inclination measuring means and the measurement value of the vehicle body inclination measuring means is smaller than a predetermined value, the calculation processing device does not execute control, and therefore slight tilting is permitted. Thus, excessive control is suppressed, enabling an improvement in riding comfort and a reduction in the load on the ECU.

Further, when the measurement value of the slope inclination measuring means is equal to or greater than a predetermined value, the calculation processing device executes control to stop the vehicle, and therefore the vehicle does not topple over on a dangerously steep incline.

### BRIEF DESCRIPTION OF THE DRAWINGS

FIG. 1A is a front view of a vehicle according to a first embodiment of the present invention, and FIG. 1B is a side view of the vehicle.

FIG. 2 is a block diagram showing an electric constitution of the vehicle.

FIG. 3A is a front view of an R motor, and FIG. 3B is a side view of the R motor.

FIG. 4A is a front view of an upper portion link and a lower portion link, and FIG. 48 is a plan view of the upper portion link and the lower portion link.

FIG. 5A is a front view of a connecting link, FIG. 5B is a side view of the connecting link, and FIG. 5C is a plan view of the connecting link.

FIG. 6 is a front view of a link mechanism.

FIG. 7 is a plan view of the link mechanism.

FIG. 8 is a pattern diagram illustrating a flexing operation of the link mechanism, FIG. 8A showing the link mechanism in a neutral position, and FIG. 8B showing the link mechanism in a flexed condition.

FIG. 9 is a block diagram showing inclined plane posture control according to the first embodiment.

FIG. 10 is a schematic diagram of the vehicle prior to the inclined plane posture control according to the first embodiment.

FIG. 11 is a flowchart showing the inclined plane posture control according to the first embodiment.

FIG. 12 is a schematic view showing the vehicle following the inclined plane posture control according to the first embodiment.

FIG. 13 is a block diagram showing inclined plane posture control according to a second embodiment.

FIG. 14 is a schematic diagram of the vehicle prior to the inclined plane posture control according to the second embodiment.

FIG. 15 is a flowchart showing the inclined plane posture control according to the second embodiment.

FIG. 16 is a view showing an optimum vehicle body inclination from a vertical plane taking a turn into account, according to the second embodiment.

FIG. 17 is a schematic view showing the vehicle following the inclined plane posture control according to the second embodiment.

FIG. 18 is a view showing another embodiment.

### BEST MODES FOR CARRYING OUT THE INVENTION

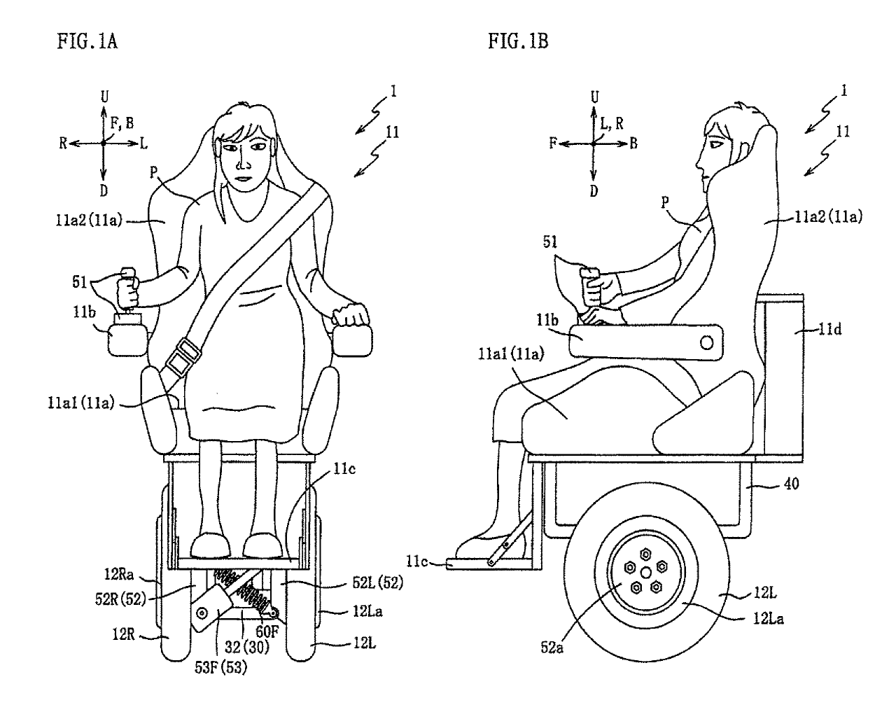

Preferred embodiments of the present invention will be described below with reference to the drawings. FIG. 1A is a front view of a traveling vehicle 1 according to a first embodiment of the present invention, and FIG. 1B is a side view of the traveling vehicle 1. Note that FIG. 1 shows a state in which a passenger P is seated on a seat 11a. Further, arrows U-D, R-L, and F-B in FIG. 1 denote an up-down direction, a right-left direction, and a front-rear direction of the traveling vehicle 1, respectively.

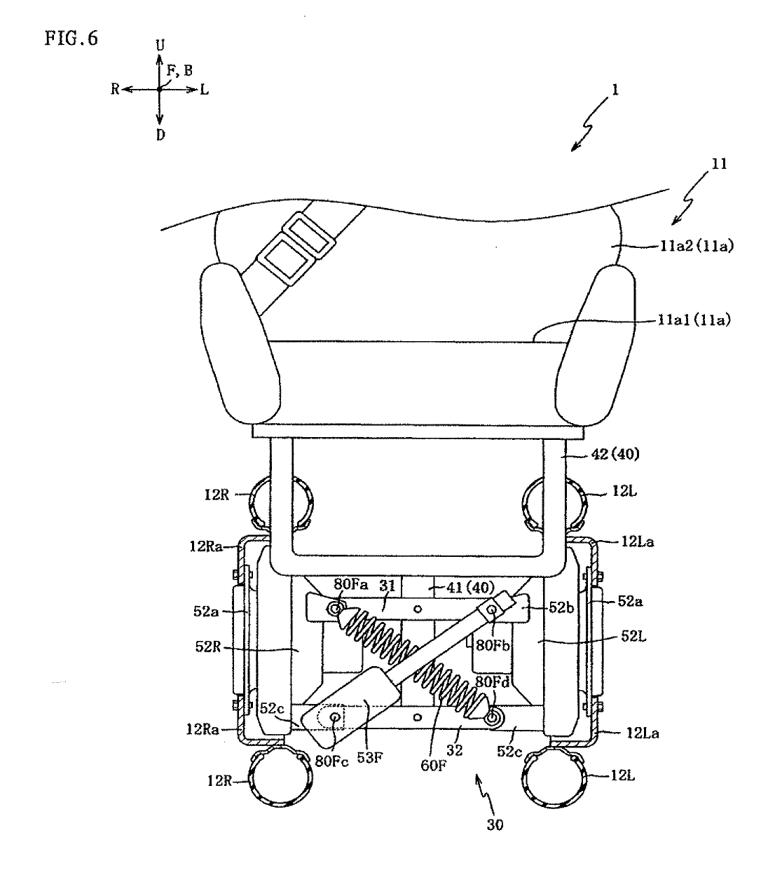

First, the schematic constitution of the traveling vehicle 1 will be described. As shown in FIG. 1, the traveling vehicle 1 mainly includes a passenger portion 11 for carrying the passenger P, right and left (i.e. a pair of) vehicle wheels 12R, 12L provided beneath the passenger portion 11 (on a lower side of FIG. 1), and a rotary driving device 52 (see FIG. 6) for applying a rotary driving force to the right and left vehicle wheels 12R, 12L. During a turn, camber angles are applied to the right and left vehicle wheels 12R, 12L and a difference is introduced into the respective rotary driving forces applied to the vehicle wheels such that the passenger portion 11 tilts to a turn inner wheel side. Thus, a turning performance can be improved and passenger comfort can be secured.

Next, the detailed constitution of each part will be described. As shown in FIG. 1, the passenger portion 11 mainly includes the seat 11a, armrests 11b, and a footrest 11c. The seat 11a is a site for seating the passenger P during travel in the traveling vehicle 1, and is mainly constituted by a seat surface portion 11a1 for supporting the bottom of the passenger P and a back surface portion 11a2 for supporting the back of the passenger P.

As shown in FIG. 1, the pair of armrests 11b for supporting the upper arms of the passenger P are provided on the right and left sides (an arrow R side and an arrow L side) of the seat 11a. A joystick device 51 is mounted on one (the arrow R side) of the armrests 11b. By operating the joystick device 51, the passenger P controls the travel condition (for example, an advancement direction, a traveling speed, a turning direction, a turning radius, and so on) of the traveling vehicle 1.

As shown in FIG. 1, the footrest 11c for supporting the feet of the passenger P is disposed below a front side (an arrow F side) of the seat 11a. Further, a case 11d is disposed on a rear side (an arrow B side) of the seat 11a, and a battery device (not shown) and so on are disposed on a bottom surface side (an arrow D side) of the seat 11a.

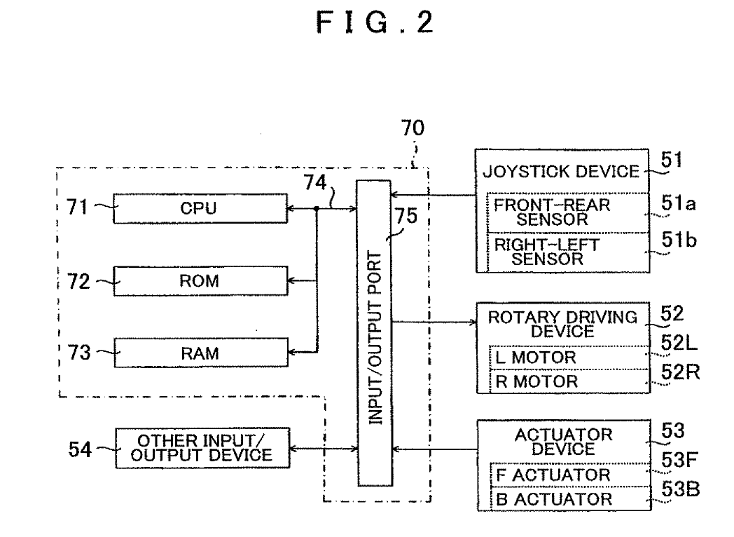

Note that the battery device serves as a drive source of a rotary driving device 52 and an actuator device 53 to be described below (see FIG. 2). Further, a case 11d houses a control device 70 to be described below (see FIG. 2), various sensor devices or an inverter device (not shown), and so on.

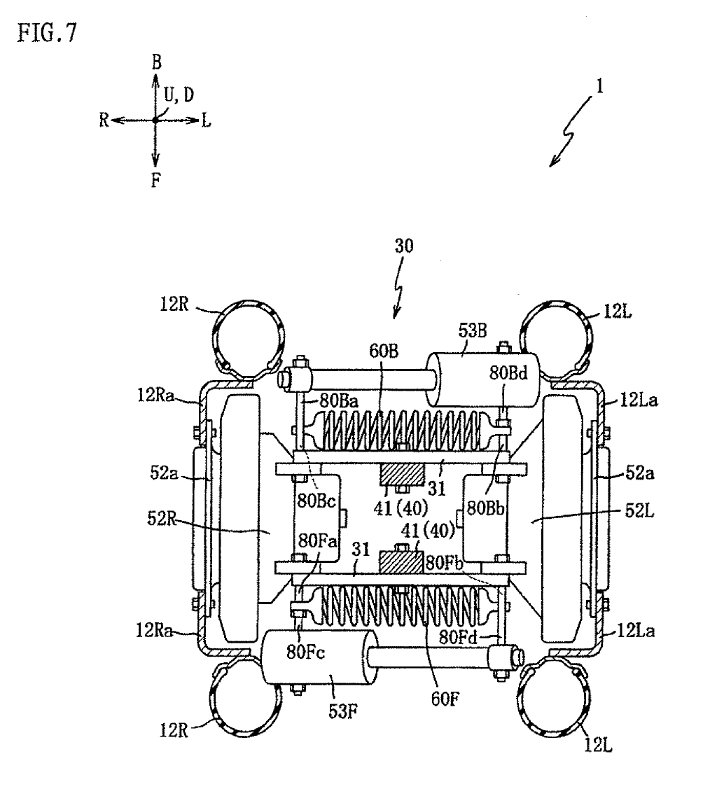

The right and left vehicle wheels 12R, 12L are supported by a link mechanism 30, to be described below, and the link mechanism 30 is connected to the passenger portion 11 via a connecting link 40 to be described below (see FIGS. 6 and 7). This constitution will be described in detail below.

Next, referring to FIG. 2, the electric constitution of the traveling vehicle 1 will be described. FIG. 2 is a block diagram showing the electric constitution of the traveling vehicle 1.

The control device 70 is a control device for controlling the various parts of the traveling vehicle 1, and as shown in FIG. 2, includes a CPU 71, a ROM 72, and a RAM 73, which are connected to an input/output port 75 via a bus line 74. Further, a plurality of devices, such as the joystick device 51, are connected to the input/output line 75.

The CPU 71 is a calculation device for controlling the various parts connected by the bus line 74. The ROM 72 is non-rewritable non-volatile memory storing a control program that is executed by the CPU 71, fixed value data, and so on. The RAM 73 is memory for rewritably storing various work data, flags, and so on during execution of the control program.

As described above, the joystick device 51 is operated by the passenger P as the passenger P drives the traveling vehicle 1, and mainly includes an operating lever (see FIG. 1) that is operated by the passenger P, a front-rear sensor 51a and a right-left sensor 51b for detecting an operating condition of the operating lever, and a processing circuit (not shown) for processing detection results of the respective sensors 51a, 51b and outputting the processed detection results to the CPU 71.

The front-rear sensor 51a is a sensor for detecting an operating condition (operation amount) of the operating lever in a front-rear direction (the F-B arrow direction, see FIG. 1). On the basis of a detection result (the front-rear operation amount of the operating lever) from the front-rear sensor 51a, the CPU 71 controls the driving condition of the rotary driving device 52. Thus, the traveling vehicle 1 is caused to travel at a traveling speed instructed by the passenger P.

The right-left sensor 51b is a sensor for detecting an operating condition (operation amount) of the operating lever in a right-left direction (the R-L arrow direction, see FIG. 1). On the basis of a detection result (the right-left operation amount of the operating lever) from the right-left sensor 51b, the CPU 71 controls the respective driving conditions of the rotary driving device 52 and the actuator device 53. Thus, the traveling vehicle 1 is turned in a turning radius instructed by the driver.

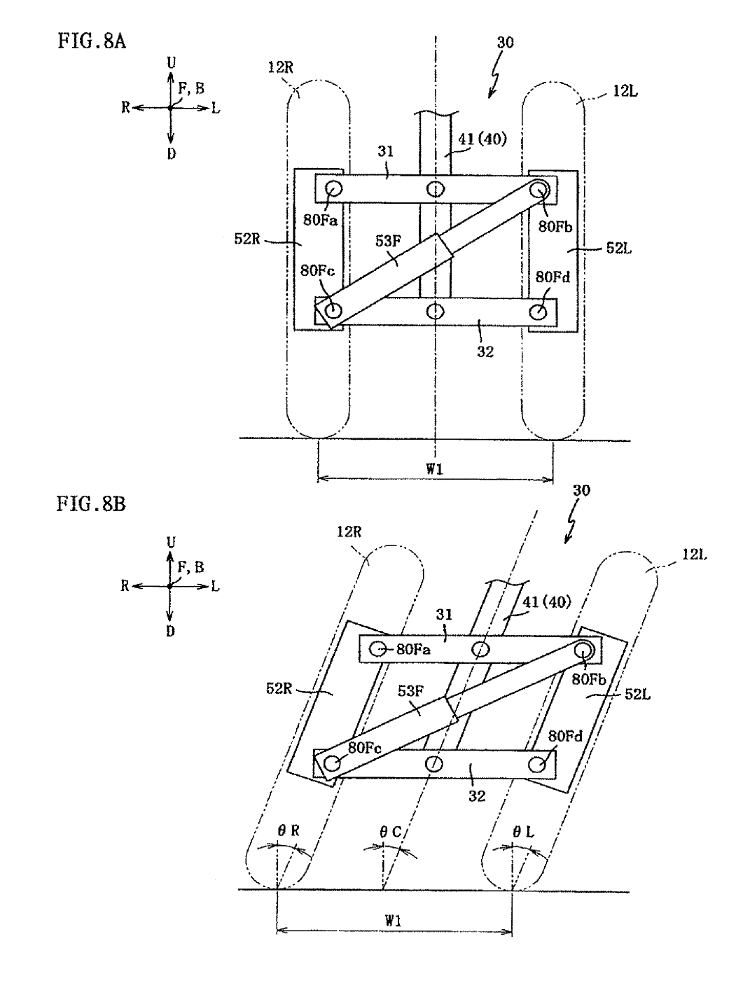

In other words, when the operating lever is operated in the right-left direction, the CPU 71 determines the turning direction and turning radius on the basis of the detection result from the right-left sensor 51b, and then drive-controls the actuator device 53 such that the right and left vehicle wheels 12R, 12L are tilted toward the turn inner side (see FIG. 8) and drive-controls the rotary driving device 52 such that the right and left vehicle wheels 12R, 12L are differentially operated in accordance with the turning radius. As a result, camber angles are applied to the right and left vehicle wheels 12R, 12L and the passenger portion 11 is tilted toward the turn inner side, thereby improving the turning performance and securing the comfort of the passenger P.

Hence, in the traveling vehicle 1 according to the present invention, camber thrust is generated by applying camber angles to the right and left vehicle wheels 12R, 12L, and the traveling vehicle 1 is turned by providing a difference in the rotary driving force of the right and left wheels. Therefore, in this embodiment, center lines of the right and left vehicle wheels 12R, 12L are kept parallel to each other and not steered to the right and left. Note, however, that a steering mechanism may be provided.

The rotary driving device 52 is a driving device for driving the right and left vehicle wheels 12R, 12L to rotate, and is mainly constituted by an L motor 52L for applying a rotary driving force to the left vehicle wheel 12L, an R motor 52R for applying a rotary driving force to the right vehicle wheel 12R, and a drive circuit and a drive source (neither of which are shown in the drawings) for drive-controlling the motors 52L, 52R on the basis of a command from the CPU 71.

The actuator device 53 is a driving device for causing the link mechanism 30, to be described below, to flex, and mainly includes an F actuator 53F disposed on a front side of the link mechanism 30 (see FIG. 7, arrow F side), a B actuator 53B disposed on a rear side of the link mechanism 30 (see FIG. 7, arrow B side), and a drive circuit and a drive source (neither of which are shown in the drawings) for drive-controlling the actuators 53L, 53B on the basis of a command from the CPU 71.

Note that in this embodiment, the actuators 53F, 53B are constituted by telescopic electric actuators, or in other words electric actuators that are capable of performing a telescopic motion using a ball screw mechanism (a mechanism including a screw shaft having a spiral screw thread in its outer peripheral surface, a nut that has a spiral screw thread corresponding to the screw thread of the screw shaft in its inner peripheral surface so as to engage with the screw shaft, a large number of rotary bodies filled rotatably between the respective screw threads of the nut and the screw shaft, and an electric motor for driving the screw shaft or the nut to rotate, wherein the screw shaft moves relative to the nut by having the electric motor drive the screw shaft or the nut to rotate).

A detection device for detecting the traveling condition (travel speed, traveled distance, and so on) of the traveling vehicle 1, a display device (not shown) for displaying the traveling condition detected by the detection device to notify the passenger P thereof, an acceleration sensor for detecting acceleration acting on the traveling vehicle 1, and so on, may be cited as examples of another input/output device 54 shown in FIG. 2.

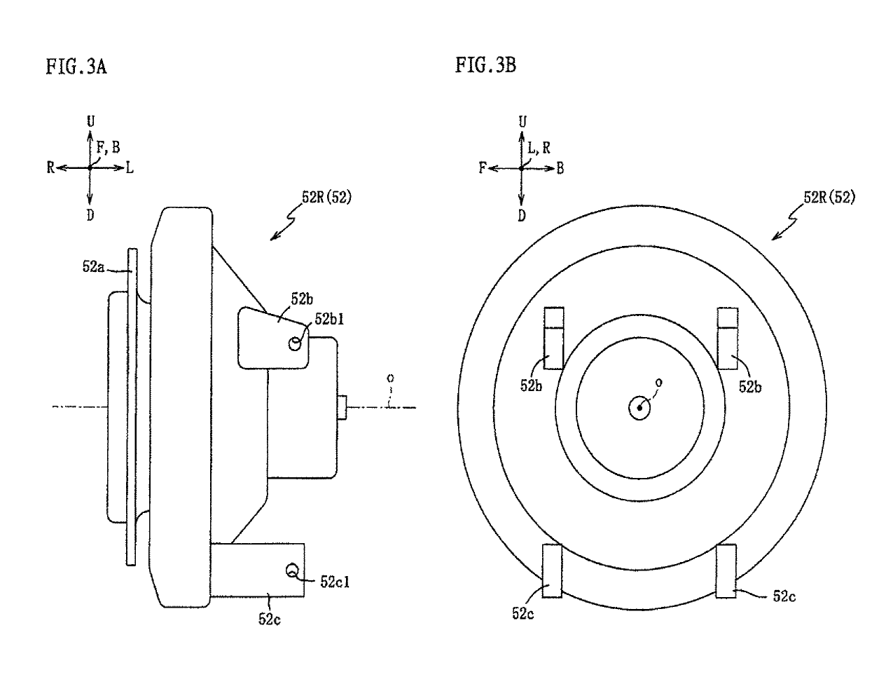

Next, referring to FIG. 3, the R and L motors 52R, 52L will be described. FIG. 3A is a front view of the R motor 52R, and FIG. 3B is a side view of the R motor 52R. Note that the R motor 52R and the L motor 52L have identical constitutions, and therefore a description of the L motor 52L will be omitted.

As described above, the R motor 52R is a driving device for applying a rotary driving force to the right vehicle wheel 12R, and is constituted by an electric motor. Further, the R motor 52R is constituted by a so-called in-wheel motor in which a hub 52a is disposed on an outer side (the arrow R side) of the traveling vehicle 1, and upper portion and lower portion axial support plates 52b, 52c are disposed on an inner side (the arrow L side) of the traveling vehicle 1.

The hub 52a is a site to which a wheel 12Ra of the right vehicle wheel 12R is fastened fixedly by a hub nut and a hub bolt (see FIGS. 6 and 7). As shown in FIG. 3A, the hub 52a is formed in a disc shape that is concentric with an axial center O of a drive shaft (not shown) of the R motor 52R. When the drive shaft of the R motor 52R is driven to rotate, the resulting rotation is transmitted to the wheel 12Ra via the hub 52a, whereby the right vehicle wheel 12R is driven to rotate.

The upper portion axial support plate 52b and the lower portion axial support plate 52c are members for axially supporting respective end portions of an upper portion link 31 and a lower portion link 32, to be described below (see FIGS. 6 and 7). As shown in FIG. 3, the upper portion axial support plate 52b and lower portion axial support plate 52c are welded fixedly to a side face (the arrow L side face) of the R motor 52R. Further, through holes 52b1, 52c1 for axially supporting the upper portion and lower portion links 31, 32 are drilled into the upper portion and lower portion axial support plates 52b, 52c, respectively.

As shown in FIG. 3B, the upper portion and lower portion axial support plates 52b, 52c are disposed in mutually opposing pairs with a predetermined interval therebetween. In this embodiment, the opposing intervals are set at equal dimensions (a dimension in the F-B arrow direction).

Further, in this embodiment, a hypothetical line linking the through hole 52b1 of the upper portion axial support plate 52b and the through hole 52c1 of the lower portion axial support plate 52c is set to intersect the axial center O of the R motor 52R. Thus, the link mechanism 30 can be formed as a four-link parallel link mechanism, as will be described below (see FIG. 8).

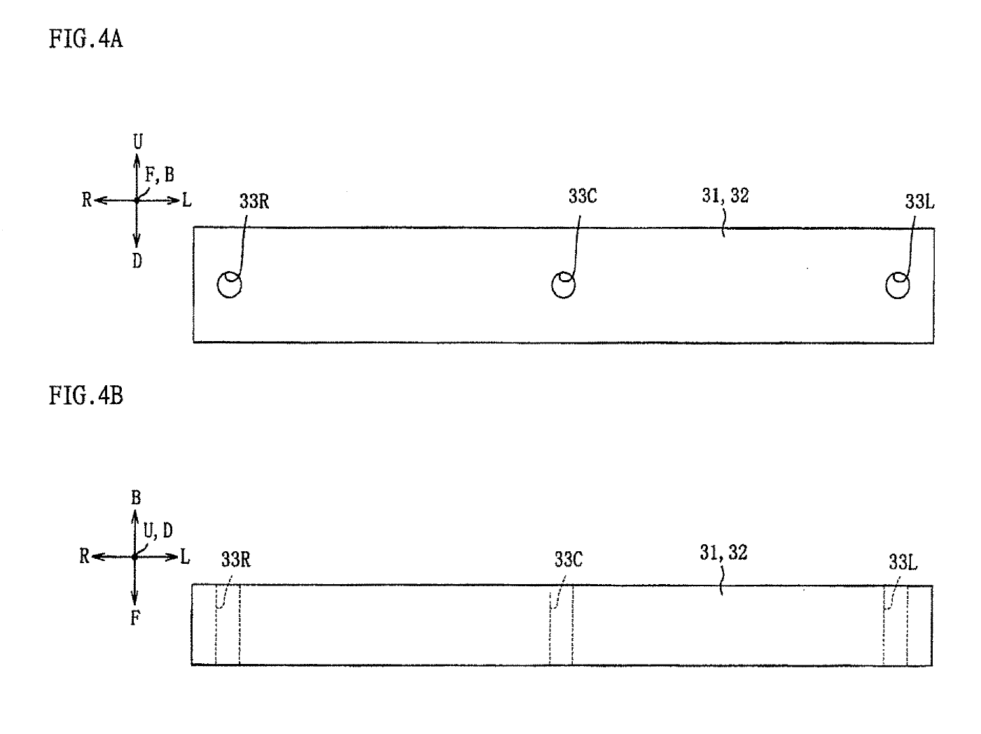

Next, referring to FIG. 4, the upper portion link 31 and lower portion link 32 will be described. FIG. 4A is a front view of the upper portion link 31 and the lower portion link 32, and FIG. 4B is a plan view of the upper portion link 31 and the lower portion link 32.

The upper portion link 31 and lower portion link 32 are axially supported on both ends by the R and L motors 52R, 52L, and together with the R and L motors 52R, 52L constitute a four-link link mechanism (see FIGS. 6 to 8). As shown in FIG. 4, the upper portion link 31 and lower portion link 32 are shaped identically, or more specifically are constituted by substantially rectangular plate-form bodies when seen from the front.

Through holes 33R, 33L drilled into the respective ends of the upper portion and lower portion links 31, 32 are sites in which the upper portion and lower portion links 31, 32 are axially supported by the upper portion axial support plate 52b (through hole 52b1) of the R and L motors 52R, 52L. Meanwhile, a through hole 33C drilled into a central portion of the upper portion and lower portion links 31, 32 in a lengthwise direction (the right-left direction in FIG. 4) is a site in which the upper portion and lower portion links 31, 32 are axially supported by a connecting link 40 to be described below (see FIGS. 6 to 8).

Further, in this embodiment, the link mechanism 30 is formed by axially supporting the respective ends of two upper portion links 31 and two lower portion links 32 on the R motor 52R and the L motor 52L. This constitution will be described in detail below (see FIGS. 6 and 7).

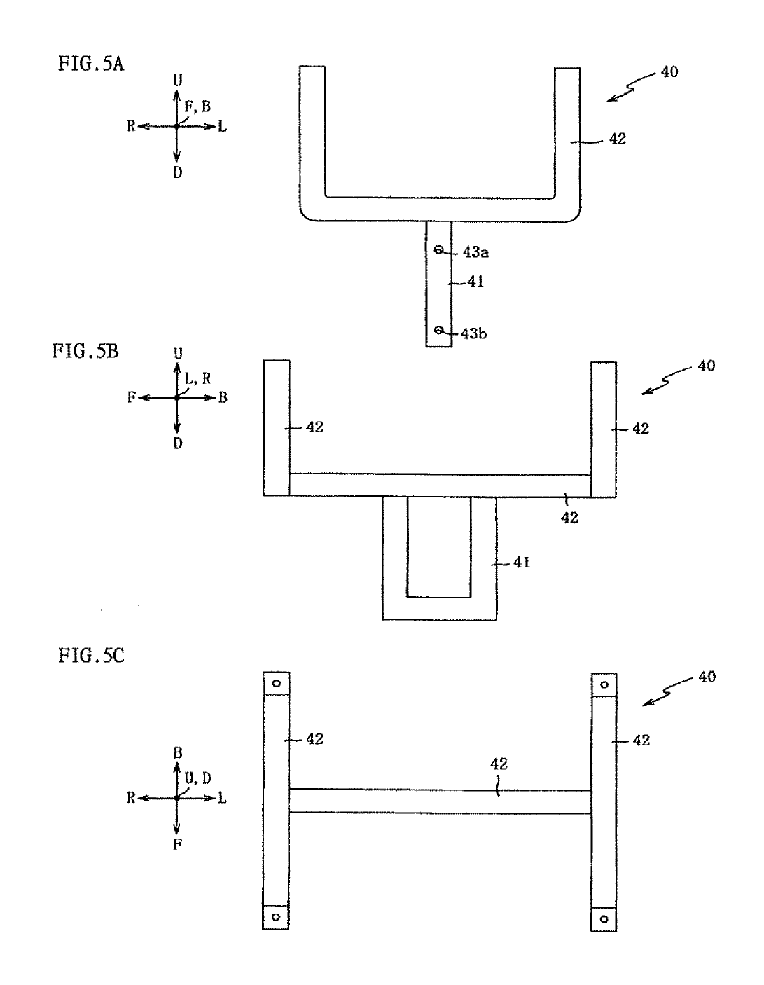

Next, referring to FIG. 5, the connecting link 40 will be described. FIG. 5A is a front view of the connecting link 40, FIG. 5B is a side view of the connecting link 40, and FIG. 5C is a plan view of the connecting link 40.

The connecting link 40 is a member for connecting the link mechanism 30 to the passenger portion 11, and mainly includes a connecting member 41 and a passenger support member 42. The connecting member 41 serves as a connecting portion with the upper portion and lower portion links 31, 32, and as shown in FIG. 5B, is formed substantially in a U shape when seen from the side such that an upper end portion thereof is connected to the passenger support portion 42 to be described below.

As shown in FIG. 5A, a through hole 43a drilled into an upper portion (an arrow U side) of the connecting member 41 is a site in which the connecting member 41 is axially supported by the through hole 33C in the upper portion link 31, and a through hole 43b drilled into a lower portion (an arrow D side) of the connecting member 41 is a site in which the connecting member 41 is axially supported by the through hole 33C in the lower portion link 32 (see FIGS. 6 to 8).

The passenger support portion 42 is a member for supporting the passenger portion 11 (the seat 11a) from a bottom surface side (the arrow D side, see FIG. 6). As shown in FIG. 5A, the passenger support portion 42 is constituted by connecting a pair of members formed substantially in a U shape when seen from the front integrally using a rod-shaped body, as shown in FIGS. 5B and 5C.

Next, referring to FIGS. 6 and 7, the constitution of the link mechanism 30 will be described in detail. FIG. 6 is a front view of the link mechanism 30, and FIG. 7 is a plan view of the link mechanism 30. Note that in FIGS. 6 and 7, to simplify the drawing and facilitate understanding, the armrests 11b, the footrest 11c, and so on are omitted and the right and left vehicle wheels 12R, 12L, the connecting link 40, and so on are shown in cross-sectional form.

As shown in FIGS. 6 and 7, the two ends of the upper portion link 31 are axially supported rotatably by the upper portion axial support plates 52b of the R motor 52R and the L motor 52L, and similarly, the two ends of the lower portion link 32 are axially supported rotatably by the lower portion axial support plates 52c of the R motor 52R and the L motor 52L. Thus, the four-link link mechanism 30 is formed as a parallel link by the upper portion and lower portion links 31, 32 and the R and L motors 52R, 52L.

In this embodiment, as shown in FIGS. 6 and 7, a pair of motor devices (i.e. the R and L motors 52R, 52L) functions as a rotary driving device for applying rotary driving force to the right and left vehicle wheels 12R, 12L, and therefore the right and left vehicle wheels 12R, 12L can be operated differentially without providing a complicated structure in which a differential device is provided and the differential device is connected to the right and left vehicle wheels 12R, 12L by a constant velocity joint, for example.

Moreover, in this embodiment, the pair of motor devices (the R and L motors 52R, 52L) functions simultaneously as a rotary driving device and a right and left pair of vehicle wheel supports, and therefore the number of components can be reduced, enabling structural simplification. As a result, reductions in weight and component/assembly cost can be achieved.

Further, as shown in FIGS. 6 and 7, the connecting link 40 is disposed such that the connecting member 41 is axially supported by the upper portion link 31 and the lower portion link 32 and the passenger support member 42 supports the passenger portion 11 (the seat 11a) from the bottom surface side. Hence, when the link mechanism 30 flexes, as will be described below, the connecting link 40 can be caused to tilt, and as a result, the passenger portion 11 can be tilted to the turn inner wheel side (see FIG. 8).

Further, as shown in FIGS. 6 and 7, the F actuator 53F and the B actuator 53B are disposed respectively on the front side (the arrow F side) and the rear side (the arrow B side) of the link mechanism 30. As described above, the F and B actuators 53F, 5313 are driving devices for flexing the link mechanism 30, and the respective ends thereof are connected to non-adjacent support shafts of the four-link link mechanism 30.

More specifically, as shown in FIGS. 6 and 7, a lower end (a main body link side) of the F actuator 53F is axially supported on the lower portion axial support plate 52c of the R motor 52R via a support shaft 80Fc, while an upper end side (rod side) thereof is axially supported on the upper portion axial support plate 52b of the L motor 52L via a support shaft 80Fb. Thus, the F actuator 53F is provided crossways on a diagonal of the four-link link mechanism 30.

Further, as shown in FIG. 7, a lower end (the main body link side) of the actuator 53B is axially supported on the lower portion axial support plate 52c of the L motor 52L via a support shaft 80Bd, while an upper end side (rod side) thereof is axially supported on the upper portion axial support plate 52b of the R motor 52R via a support shaft 80Ba. Thus, the B actuator 5313 is provided crossways on a diagonal of the four-link link mechanism 30. Further, the F and B actuators 53F, 53B are disposed in mutually intersecting orientations.

Hence, the respective ends of the F and B actuators 53F, 53B are connected to non-adjacent support shafts of the four-link link mechanism 30 (in other words, provided crossways on diagonals of the four-link link mechanism 30), and therefore a distance from a force acting point (in the case of the F actuator 53F, for example, the support shaft 80Fb and the support shaft 80Fc, as shown in FIG. 6) to a rotary center (remaining support shafts 80Fa and 80Fd to which the ends of the F actuator 53F are not connected) is maximized, enabling a corresponding reduction in the driving force required to flex the link mechanism 30.

As a result, the link mechanism 30 can be flexed smoothly (i.e. at high speed and with a high degree of precision), and the driving performance required for the actuators (the F and B actuators 53F, 538) can be suppressed to a low level. Therefore, the actuators, the drive sources thereof, and so on can be reduced in size, enabling reductions in weight and component cost.

When the link mechanism 30 is further provided with an arm to increase the distance from the force acting point to the rotary center, an increase in weight corresponding to the arm occurs, and when the link mechanism 30 flexes, the arm and the actuators project outward from the outer form of the link mechanism, making it impossible to achieve a size reduction.

However, when the ends of the actuators (the F and B actuators 53F, 53B) are provided crossways on the diagonals of the link mechanism, as in this embodiment, the distance can be maximized without providing an arm, and therefore the actuators can be prevented from projecting outward from the outer form of the link mechanism when the link mechanism 30 is flexed, enabling a reduction in size.

As described above, the pair of actuators (the F and B actuators 53F, 53B) are disposed in mutually intersecting orientations, and therefore, in contrast to a case in which the actuators are disposed in the same direction, the link mechanism 30 can be flexed evenly in all directions such that stability can be secured during a turning operation.

In a constitution where a single actuator is provided crossways on a diagonal of the four-link link mechanism 30, for example, when the actuator is extended to cause the link mechanism 30 to flex in a single direction (corresponding to a right turn, for example) from a neutral position, an angle formed by a force acting direction and the link of the link mechanism 30 (for example, an angle formed by the F actuator 53F and the L motor 52L in FIG. 5B) gradually approaches 0° as the actuator extends.

In other words, the proportion of a force component for rotating the link of the link mechanism 30 (more specifically, a force component in an orthogonal direction to a hypothetical line connecting the rotary center of the single link to the force acting point; in FIG. 5B, for example, using the L motor 52L as the single link, the rotary center of the single link is the support shaft 80Fd and the force acting point is the support shaft 80Fb, and therefore the hypothetical line is a line connecting the support shaft 80Fd and the support shaft 80Fb) relative to the force acting on the link mechanism 30 from the actuator is reduced.

On the other hand, when the actuator is contracted to cause the link mechanism 30 to flex in another direction (corresponding to a left turn) from the neutral position, the angle formed by the force acting direction and the link of the link mechanism 30 gradually approaches 90° as the actuator contracts.

In other words, the proportion of the force component for rotating the link of the link mechanism 30 (more specifically, a force component in an orthogonal direction to the hypothetical line connecting the rotary center of the single link to the force acting point) relative to the force acting on the link mechanism 30 from the actuator is increased.

Hence, when the link mechanism 30 is flexed, a greater driving force is required to extend the actuator than to cause the actuator to contract (in other words, the link mechanism 30 can be flexed using a smaller amount of driving force when the actuator is contracted than when the actuator is extended).

Accordingly, when the actuators (the F and B actuators 53F, 5313) are provided in a pair, and the pair of actuators are disposed in the same direction, different driving forces are required to flex the link mechanism 30 in one direction (i.e. to extend the actuator) and to flex the link mechanism 30 in another direction (i.e. to contract the actuator), and therefore, it is difficult to match a flexure amount and a flexure speed of the link mechanism 30 in both directions (i.e. a right turn and a left turn) with a high degree of precision.

As a result, flexure of the link mechanism 30, or in other words the turning operation of the traveling vehicle 1, becomes unstable, leading to deterioration of the operating feeling of the passenger P and the turning performance. Furthermore, operation control of the actuators becomes complicated, leading to an increase in control cost.

In this embodiment, on the other hand, the pair of actuators (the F and B actuators 53F, 53B) are disposed in intersecting orientations, and therefore the link mechanism 30 can be flexed in all directions using an identical driving force, whereby stability can be secured in the flexure operation (the turning performance) and the control costs of the CPU 71 can be reduced.

Note that in this embodiment, as shown in FIGS. 6 and 7, the F and B actuators 53F, 53B are disposed such that the main body link side thereof is positioned below the rod side. Hence, the site having increased weight is positioned below the traveling vehicle 1, thereby lowering the center of gravity position of the traveling vehicle 1, and as a result, a corresponding improvement in the turning performance can be achieved.

As shown in FIGS. 6 and 7, elastic spring devices 60F, 60B are disposed respectively on the front side (the arrow F side) and the rear side (the arrow B side) of the link mechanism 30. The elastic spring devices 60F, 60B are driving devices for returning the link mechanism 30 to a neutral position by applying a biasing force to the link mechanism 30 when the link mechanism 30 is flexed in any direction, and are constituted by metal coil springs.

The elastic spring devices 60F, 60B are formed in the same shape from an identical material, and similarly to the F and B actuators 53F, 53B, the respective ends thereof are connected to non-adjacent support shafts of the four-link link mechanism 30.

More specifically, as shown in FIGS. 6 and 7, a lower end side of the elastic spring device 60F is axially supported by the lower portion axial support plate 52c of the L motor 52L via a support shaft 80Fd, while an upper end side thereof is axially supported by the upper portion axial support plate 52b of the R motor 52R via a support shaft 80Fa. Thus, the elastic spring device 60F is provided crossways on a diagonal of the four-link link mechanism 30 while intersecting the F actuator 53F.

Further, as shown in FIG. 7, a lower end of the elastic spring device 60B is axially supported by the lower portion axial support plate 52c of the R motor 52R via a support shaft 80Bc, while an upper end side thereof is axially supported by the upper portion axial support plate 52b of the L motor 52L via a support shaft 80Bb. Thus, the elastic spring device 60B is provided crossways on a diagonal of the four-link link mechanism 30 while intersecting the B actuator 53B. Furthermore, the elastic spring mechanisms 60F, 60B are also disposed in mutually intersecting orientations.

Hence, in this embodiment, the elastic spring devices 60F, 60B are provided such that when the link mechanism 30 is flexed in any direction, a biasing force can be applied to the link mechanism 30 to return the link mechanism 30 to a neutral position, and as a result, the need to hold the link mechanism 30 in the neutral position by constantly driving the F and B actuators 53F, 53B can be eliminated. Hence, control and driving to hold the link mechanism 30 in the neutral position are unnecessary, enabling reductions in control cost and driving cost.

Further, the F and B actuators 53F, 53B need only be driven when the link mechanism 30 is flexed in any direction, and driving to return the link mechanism 30 to the neutral position is not required, enabling a corresponding reduction in driving cost. Note, however, that the F and B actuators 53F, 53B may be driven when returning the link mechanism 30 to the neutral position. In so doing, the returning process can be increased in speed and the turning condition can be stabilized.

Furthermore, in this embodiment, as described above, the elastic spring devices 60F, 60B are disposed in mutually intersecting orientations, and therefore, similarly to the actuators (the F and 13 actuators 53F, 53B), the operations for returning the link mechanism 30 to the neutral position and holding the link mechanism 30 in the neutral position can be stabilized in comparison with a case in which the elastic spring devices 60F, 60B are disposed in the same direction.

Next, an operation of the link mechanism 30 constituted in the above manner will be described. FIG. 8 is a pattern diagram illustrating a flexure operation of the link mechanism 30 and corresponding to a front view of the link mechanism 30. Note that in FIG. 8, the R and L motors 52R, 52L and so on are illustrated in pattern form, and the elastic spring devices 60F and so on are omitted.

As shown in FIG. 8A, when the link mechanism 30 is in the neutral position, the camber angles of the right and left vehicle wheels 12R, 12L are 0°. The inclination of the connecting link is also 0°. Then, when the F actuator 53F is driven to extend, the link mechanism 30 is flexed, as shown in FIG. 8B, whereby predetermined camber angles θR, θL are applied to the right and left vehicle wheels 12R, 12L and a predetermined inclination θC is applied to the connecting link 40.

Note that in this embodiment, the link mechanism 30 is constituted by a parallel link mechanism, and therefore the camber angles θR, θL and the inclination θC all take identical values. Further, when the F actuator 53F is driven to extend (driven to contract), the B actuator 53B is driven to contract (driven to extend).

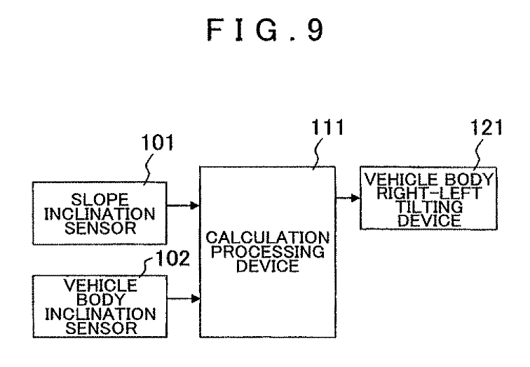

Next, posture control according to the first embodiment, which is performed on the vehicle when the vehicle crosses an inclined plane, will be described. FIG. 9 is a block diagram relating to an inclined plane posture control device according to the first embodiment. In FIG. 9, 101 denotes a slope inclination sensor serving as an example of slope inclination measuring means, 102 denotes a vehicle body inclination sensor serving as an example of vehicle body inclination measuring means, 111 denotes a calculation processing device, and 53 denotes an actuator device serving as a vehicle body right-left tilting device.

The slope inclination sensor 101 determines the inclination of a slope, and is constituted by a posture sensor such as a gravity sensor. The slope inclination sensor 101 is preferably disposed on an arm linking the vehicle wheels 12 to the vehicle body or the like, for example, so that it is not affected by the tilt of a vehicle body 2 including the passenger portion 11. Alternatively, the slope inclination sensor 101 may be disposed in a part of the vehicle body that tilts, for example below the seat 11a, in order to determine the posture by subtracting the vehicle body inclination from a value obtained in this position.

The vehicle body inclination sensor 102 determines the inclination of the vehicle body 2 including the passenger portion 11 by measuring an inter-link angle of the vehicle body square link mechanism 30. Alternatively, the vehicle body inclination sensor 102 may calculate the vehicle body inclination from the position (length) of the actuator device 53 for tilting the vehicle body. At this time, the position (length) of the actuator device 53 may be measured directly or a command value issued to the actuator device 53 may be used.

The calculation processing device 111 controls the actuator device 53 using the measurement values of the slope inclination sensor 101 and the vehicle body inclination sensor 102.

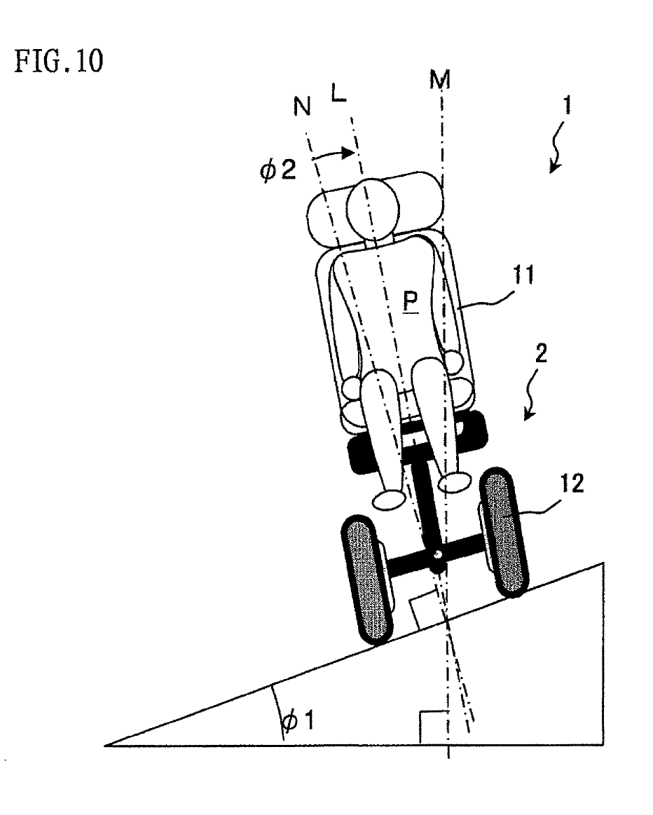

FIG. 10 is a schematic diagram showing the traveling vehicle 1 when traveling on an inclined plane. In the drawing, φ1 is the inclination of the inclined plane, φ2 is a vehicle body posture angle relative to a perpendicular normal to the slope, L is a vehicle central axis, M is a vertical, and N is the perpendicular normal to the slope.

The inclined plane inclination φ1 is determined by the slope inclination sensor 101, and is identical to the angle of the normal N that is perpendicular to the slope relative to the vertical M. The inclined plane inclination φ1 is set to be positive on one of a left tilt and a right tilt, and negative on the other. The vehicle body posture angle φ2 is determined by the vehicle body inclination sensor 102, and is a vehicle body posture angle relative to the normal N that is perpendicular to the slope.

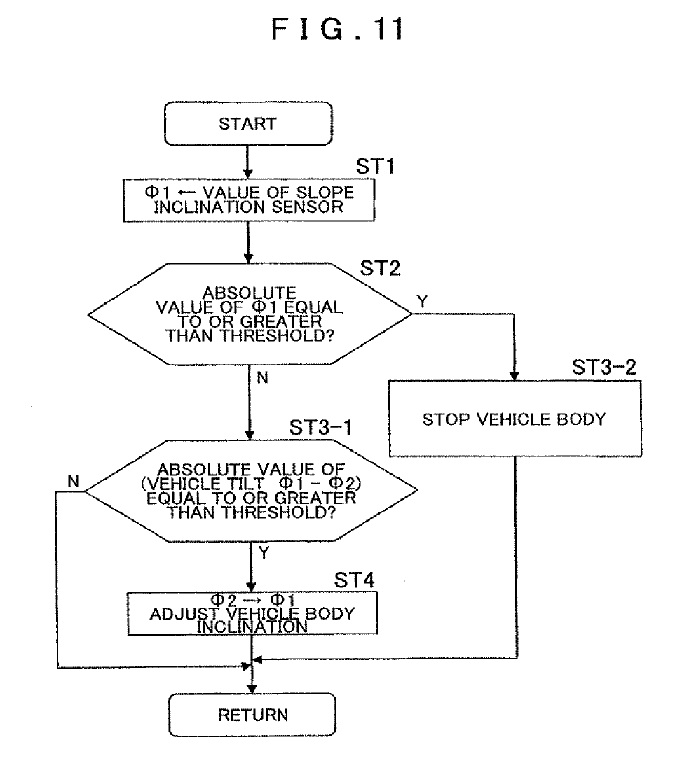

An operation of the inclined plane posture control device of the traveling vehicle 1 during travel on an inclined plane in this condition will now be described using a flowchart. FIG. 11 is a flowchart showing inclined plane posture control performed in the traveling vehicle 1 during travel on an inclined plane.

First, in a step 1, the inclination φ1 of the inclined plane is determined from the value of the slope inclination sensor 101 (ST1). Next, in a step 2, a determination is made as to whether or not an absolute value of the inclination φ1 of the inclined plane is equal to or greater than a predetermined threshold a (ST2). When it is determined in the step 2 that the absolute value of the inclination φ1 of the inclined plane is not equal to or greater than the threshold α, a determination is made in a step 3-1 as to whether or not an absolute value of a vehicle body tilt (φ1-φ2) relative to the vertical is equal to or greater than a predetermined threshold β (ST3-1). When it is determined in the step 2 that the absolute value of the inclination φ1 of the inclined plane is equal to or greater than the threshold α, it is determined that the incline is large, and therefore that an emergency condition is present, and accordingly, travel of the traveling vehicle 1 is halted in a step 3-2 (ST3-2).

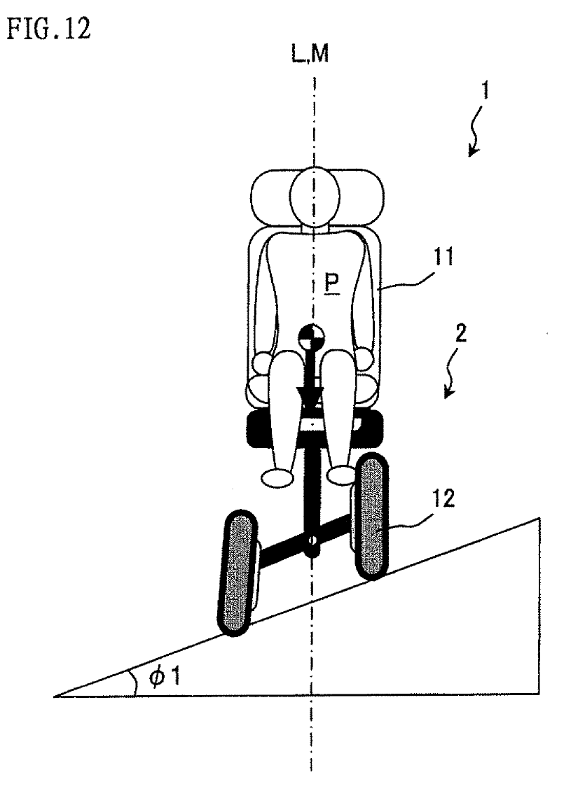

When the absolute value of the vehicle body tilt (φ1-φ2) relative to the vertical M is equal to or greater than the threshold β in the step 3-1, the actuator device 53 is used in a step 4 to adjust the vehicle body tilt (φ1-φ2) relative to the vertical M to 0 such that the vehicle body 2 is controlled to a substantially horizontal condition (ST4), as shown in FIG. 12. When the absolute value of the vehicle body tilt (φ1-φ2) relative to the vertical M is smaller than the threshold 13 in the step 3-1, control is not executed. Since control is not executed, a slight tilt is permitted in the vehicle body 2, and therefore excessive control can be avoided, enabling an improvement in riding comfort and a reduction in the load on an ECU. By executing this inclined plane posture control repeatedly, the vehicle body 2 can be controlled to a substantially horizontal condition or within a permissible range at all times.

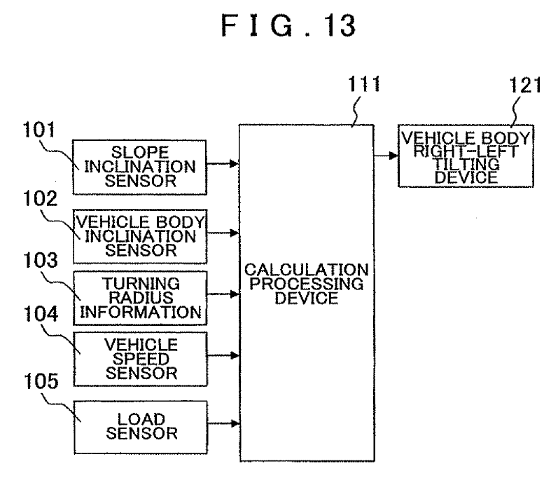

Next, posture control according to a second embodiment, which is performed on the traveling vehicle 1 during a turn on an inclined plane, will be described. FIG. 13 is a block diagram relating to an inclined plane posture control device according to the second embodiment. In FIG. 13, 101 denotes the slope inclination sensor, 102 denotes the vehicle body inclination sensor, 103 denotes turning radius measuring means, 104 denotes a vehicle speed sensor, 111 denotes the calculation processing device, and 53 denotes the actuator device serving as the vehicle body right-left tilting device.

The slope inclination sensor 101, vehicle body inclination sensor 102, and actuator device 53 are identical to their counterparts in the first embodiment. The turning radius measuring means 103 are capable of obtaining a turning radius R from operation command values relating to the front-rear sensor 51a and the right-left sensor 51b of the joystick device 51, the rotary angles of the right and left wheels 12 or the angular velocity of the right and left wheels 12, and so on. The vehicle speed sensor 104 is a sensor for measuring a vehicle speed V of the vehicle.

The calculation processing device 111 controls the actuator device 53 using measurement values of the slope inclination sensor 101, the vehicle body inclination sensor 102, the turning radius measuring means 103, and the vehicle speed sensor 104.

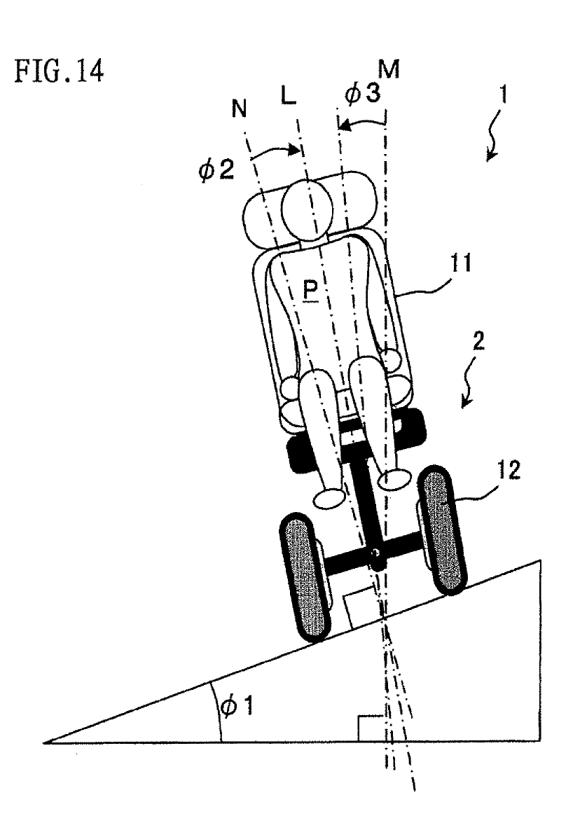

FIG. 14 is a schematic diagram showing the traveling vehicle 1 prior to inclined plane posture control performed during a turn while traveling on an inclined plane. In the drawing, φ1 is the inclination of the inclined plane, φ2 is the vehicle body posture angle relative to the perpendicular normal to the slope, φ3 is a vehicle body inclination that takes into account a turn relative to the vertical, L is the vehicle central axis, M is the vertical, and N is the perpendicular normal to the slope.

The inclined plane inclination φ1 is determined from the slope inclination sensor 101, and is identical to the angle of the normal N that is perpendicular to the slope relative to the vertical M. The inclined plane inclination 41 is set to be positive on one of the left tilt and the right tilt, and negative on the other. The vehicle body posture angle φ2 is determined from the vehicle body inclination sensor 102, and is a vehicle body posture angle relative to the normal N that is perpendicular to the slope.

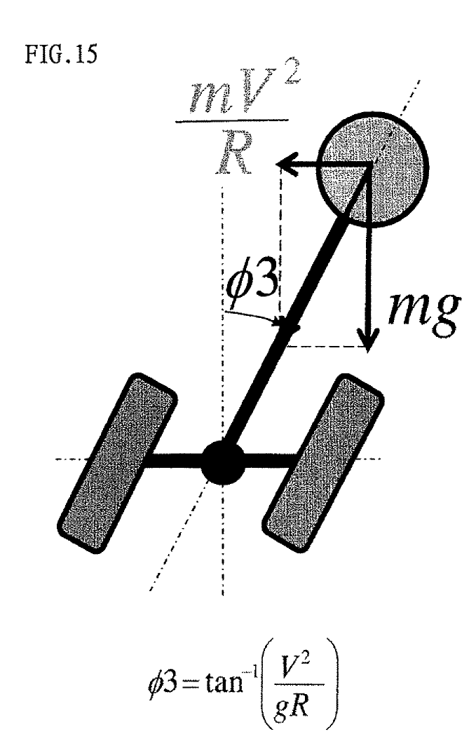

The vehicle body inclination φ3 takes centrifugal force and so on into account, and is an optimum vehicle body inclination from the vertical taking into account a turn determined from the vehicle speed V and the turning radius R. As shown in FIG. 15, the vehicle body inclination φ3 is expressed by

φ3=tan⁻¹(V²/gR) (1)

At this time, a vehicle mass m is canceled out, and does not therefore need to be determined using a sensor or the like.

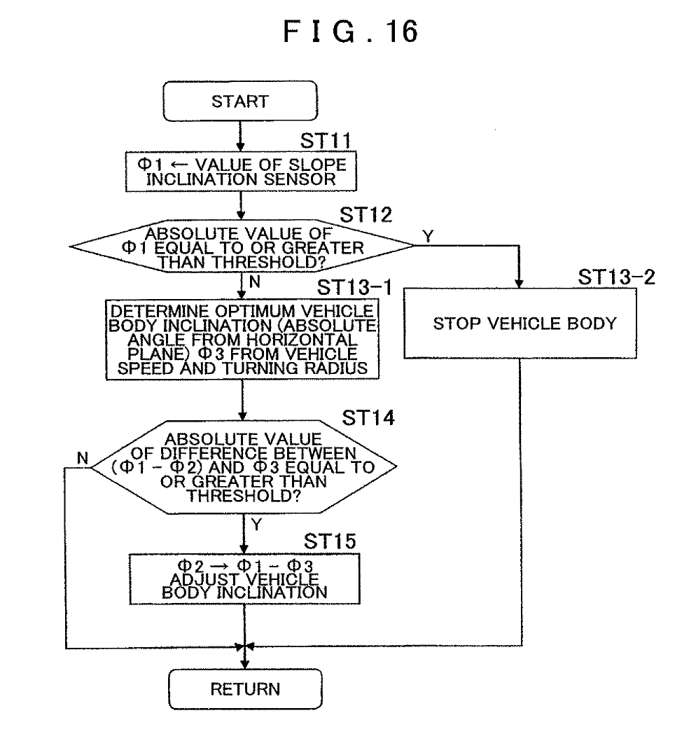

An operation of the inclined plane posture control device of the traveling vehicle 1 during travel on an inclined plane in this condition will now be described using a flowchart. FIG. 16 is a flowchart showing inclined plane posture control performed in the traveling vehicle 1 during travel on an inclined plane.

First, in a step 11, the inclination φ1 of the inclined plane is determined from the value of the slope inclination sensor 101 (ST11). Next, in a step 12, a determination is made as to whether or not an absolute value of the inclination φ1 of the inclined plane is equal to or greater than a predetermined threshold a (ST12). When it is determined in the step 12 that the absolute value of the inclination 41 of the inclined plane is not equal to or greater than the threshold α, the vehicle body inclination φ3 is determined from Equation (1) in a step 13-1 (ST13-1), When it is determined in the step 12 that the absolute value of the inclination φ1 of the inclined plane is equal to or greater than the threshold α, it is determined that the incline is large, and therefore that an emergency condition is present, and accordingly, travel of the traveling vehicle 1 is halted in a step 13-2 (ST13-2).

Next, in a step S14, a difference between the vehicle tilt (φ1-φ2) relative to the vertical M and φ3 determined in the step 13-1 is determined, and a determination is made as to whether or not an absolute value of this difference is equal to or greater than a predetermined threshold γ (ST14).

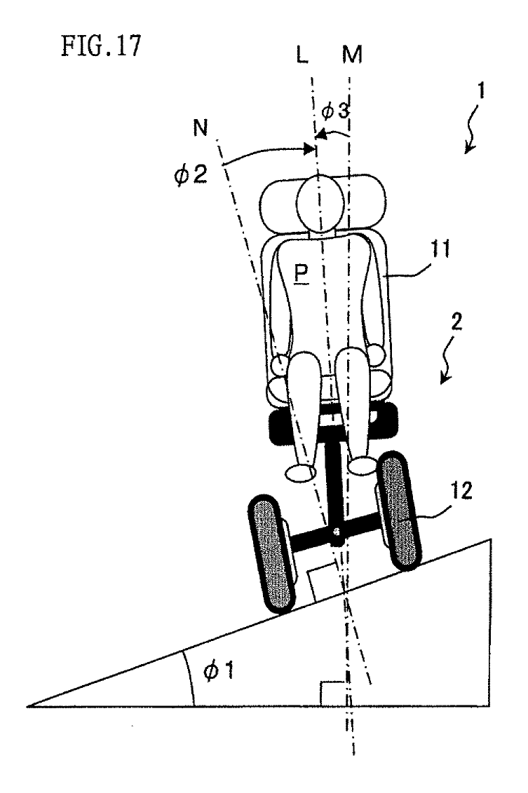

When the absolute value of the difference between the vehicle tilt (φ1-φ2) relative to the vertical M and φ3 determined in the step 13-1 is equal to or greater than the threshold γ, the vehicle body is controlled by the actuator 53, such as the actuator device 53, in a step 15 to set the vehicle tilt (φ1-φ2) relative to the vertical M at φ3 determined in the step 13-1, or in other words to set the vehicle tilt (φ1-φ2) relative to the vertical M at φ3, as shown in FIG. 17 (ST15). When the absolute value of the difference between the vehicle tilt (φ1-φ2) relative to the vertical M and φ3 determined in the step 13-1 is not equal to or greater than the threshold γ in the step 14, control is not executed. When control is not executed, a slight tilt is permitted in the vehicle body 2, and therefore excessive control can be avoided, enabling an improvement in riding comfort and a reduction in the load on the ECU. By executing this inclined plane posture control repeatedly, the posture of the vehicle body can be controlled within a permissible range that takes the turn into account at all times.

Note that the slope inclination sensor 101 and the vehicle body inclination sensor 102 may be integrated. For example, in both cases where the tilt is and is not taken into account, (φ1-φ2) in the flow is determined directly from a value of a posture sensor (gravity sensor) attached to the tilting part of the vehicle body. In this case, even when the vehicle body tilting actuator is constituted by an inexpensive device (which can only be commanded to extend and contract and cannot be commanded to move to a precise position) rather than a servo, a command can be issued to the actuator such that the value of (φ1-φ2) approaches a target value, and thus tilting of the vehicle body can be realized through feedback of (φ1-φ2).

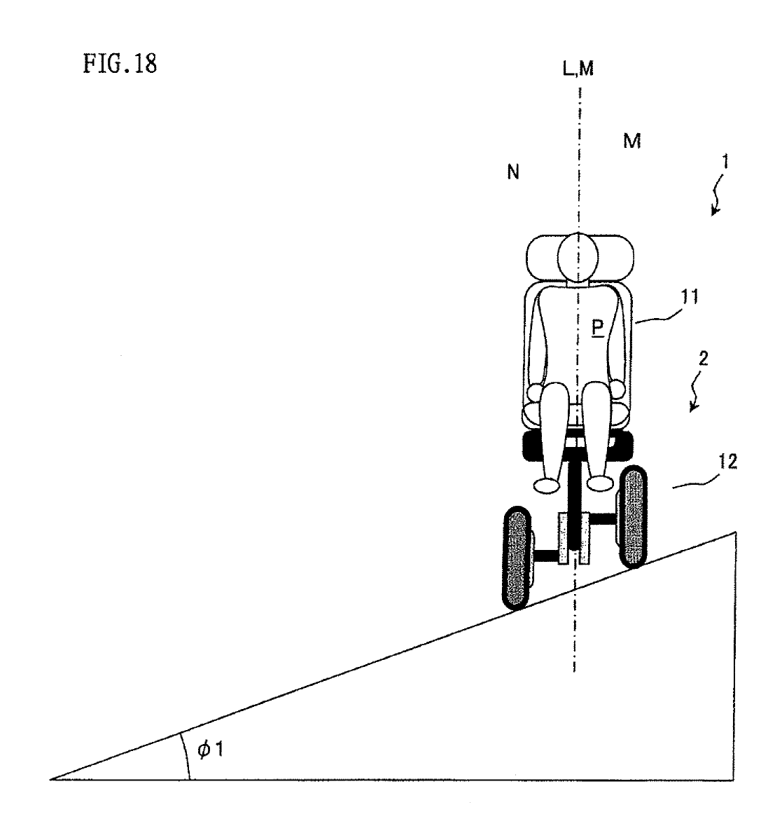

Further, in another embodiment, as shown in FIG. 18, a telescopic actuator 153 may be provided between the vehicle body 2 and the support part of the vehicle wheels 12 such that the height of a vehicle wheel attachment position can be modified.

With this constitution, the posture of the vehicle body can be controlled appropriately in accordance with the inclination of the slope such that when the vehicle body 2 is controlled to be substantially horizontal, riding comfort is improved, leading to an improvement in passenger comfort. Further, by positioning the center of gravity in the center of the tread, improvements in right-left stability and advancement performance are achieved. Further, when the absolute value of the difference between the measurement values of the slope inclination sensor 101 and the vehicle body inclination sensor 102 is smaller than a predetermined value, control is not executed, and therefore slight tilting is permitted. Thus, excessive control is suppressed, enabling an improvement in riding comfort and a reduction in the load on the ECU. Moreover, the vehicle body right-left tilting device is controlled to a vehicle body inclination that takes the turn into account from the measurement values of the turning radius measuring means 103 and the vehicle speed detecting means 104, and therefore finer control can be performed. Furthermore, when the absolute value of a difference between a posture angle that takes the turn into account and the difference between the measurement value of the slope inclination sensor 101 and the measurement value of the vehicle body inclination sensor 102 is smaller than a predetermined value, control is not executed, and therefore slight tilting is permitted. Thus, excessive control is suppressed, enabling an improvement in riding comfort and a reduction in the load on the ECU. Further, when the measurement value of the slope inclination sensor 101 is equal to or greater than a predetermined value, control is performed to stop the vehicle, and therefore the vehicle does not topple over on a dangerously steep incline.

### INDUSTRIAL APPLICABILITY

As described above, the traveling vehicle according to the present invention is capable of appropriately controlling the posture of a vehicle body in accordance with an inclination of a slope. Further, by permitting slight tilting so that excessive control is suppressed, riding comfort is improved and the load on an ECU is reduced. Moreover, the vehicle does not topple over on a dangerously steep incline.

1. A traveling vehicle comprising:
a vehicle body;
vehicle wheels that are supported rotatably by the vehicle body and provided in parallel;
a vehicle body right-left tilting device that tilts the vehicle body to the right and left relative to the vehicle wheels;
slope inclination measuring means for measuring an inclination of a slope;
vehicle body inclination measuring means for measuring an inclination of the vehicle body relative to a vertical of the slope; and
a calculation processing device for controlling the vehicle body right-left tilting device in accordance with values measured by the slope inclination measuring means and the vehicle body inclination measuring means.

2. The traveling vehicle according to claim 1, wherein:
the calculation processing device controls the vehicle body to be substantially horizontal.

3. The traveling vehicle according to claim 2, wherein:
when an absolute value of a difference between the measurement values of the slope inclination measuring means and the vehicle body inclination measuring means is smaller than a predetermined value, the calculation processing device does not execute control.

4. The traveling vehicle according to claim 1, further comprising:
turning radius measuring means for measuring a turning radius when the traveling vehicle performs a turn; and
vehicle speed detecting means for measuring a vehicle speed of the traveling vehicle, and wherein:
the calculation processing device controls the vehicle body right-left tilting device to a vehicle body inclination that takes the turn into account from measurement values of the turning radius measuring means and the vehicle speed detecting means.

5. The traveling vehicle according to claim 4, wherein:
when an absolute value of a difference between a posture angle that takes the turn into account and the difference between the measurement value of the slope inclination measuring means and the measurement value of the vehicle body inclination measuring means is smaller than a predetermined value, the calculation processing device does not execute control.

6. The traveling vehicle according to claim 1 wherein:
when the measurement value of the slope inclination measuring means is equal to or greater than a predetermined value, the calculation processing device executes control to stop the vehicle.

7. The traveling vehicle according to claim 2, wherein:
when the measurement value of the slope inclination measuring means is equal to or greater than a predetermined value, the calculation processing device executes control to stop the vehicle.

8. The traveling vehicle according to claim 3, wherein:
when the measurement value of the slope inclination measuring means is equal to or greater than a predetermined value, the calculation processing device executes control to stop the vehicle.

9. The traveling vehicle according to claim 4, wherein:
when the measurement value of the slope inclination measuring means is equal to or greater than a predetermined value, the calculation processing device executes control to stop the vehicle.

10. The traveling vehicle according to claim 5, wherein:
when the measurement value of the slope inclination measuring means is equal to or greater than a predetermined value, the calculation processing device executes control to stop the vehicle.
